(19) United States
(12) Patent Application Publication
(10) Pub. No.: US 2026/0143070 A1
(43) Pub. Date: May 21, 2026

(54) INPUT DEVICE AND IMAGE FORMING APPARATUS

(71) Applicant: Satoshi ODANAKA, Kanagawa (JP)

(72) Inventor: Satoshi ODANAKA, Kanagawa (JP)

(21) Appl. No.: 19/351,326

(22) Filed: Oct. 7, 2025

(30) Foreign Application Priority Data
Nov. 21, 2024 (JP) 2024-203309

(51) Int. Cl. H04N 1/00

(52) U.S. Cl. CPC H04N 1/00411; H04N 1/00392; H04N 2201/0094

(57) ABSTRACT

An input device includes a display, a first detector, a second detector, and circuitry. The first detector has a first detection surface to detect an object contacting the first detection surface to detect a contact operation performed by the object. The second detector detects the object on the second detection surface to detect a non-contact operation performed by the object. The second detection surface is separated from the first detection surface. The circuitry determines that the non-contact operation is performed on the second detection surface by the object when the second detector detects the object on the second detection surface and when the first detector does not detect the object contacting the first detection surface; disables the second detection surface when the first detector detects that the object contacts the first detection surface; and determines a type of the contact operation performed on the first detection surface by the object.

### CROSS-REFERENCE TO RELATED APPLICATION

This patent application is based on and claims priority pursuant to 35 U.S.C. § 119 (a) to Japanese Patent Application No. 2024-203309, filed on Nov. 21, 2024, in the Japan Patent Office, the entire disclosure of which is hereby incorporated by reference herein.

### BACKGROUND

### Technical Field

The present disclosure relates to an input device and an image forming apparatus.

### Related Art

For input operations on devices, a method of directly touching a screen such as that using a touch panel is commonly adopted. This input method has become one of the most frequently used input methods at present owing to the intuitive operations, the certainty and reliability created by the touch, and the ability to handle sensitive input.

### SUMMARY

The present disclosure described herein provides an input device including a display, a first detector, a second detector, and circuitry. The display has a display surface and displays information. The first detector has a first detection surface parallel to the display surface, to detect an object contacting the first detection surface to detect a contact operation performed by the object. The second detector emits light to form a second detection surface and detects the object on the second detection surface to detect a non-contact operation performed by the object. The second detection surface is parallel to the first detection surface and separated from the first detection surface by a predetermined distance. The circuitry determines that the non-contact operation is performed on the second detection surface by the object when the second detector detects the object on the second detection surface and when the first detector does not detect the object contacting the first detection surface; disables the second detection surface when the first detector detects that the object contacts the first detection surface; and determines a type of the contact operation performed on the first detection surface by the object when the second detection surface has been disabled.

The present disclosure described herein provides an image forming apparatus including the input device as described above and a plotter to form an image according to a movement of the object detected by the first detector and the second detector of the input device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an example of an image forming apparatus according to an embodiment of the present disclosure;

FIG. 2 is an external perspective view of an operation input device installed in the image forming apparatus according to the embodiment;

FIG. 3 is a cross-sectional view of the operation input device installed in the image forming apparatus according to the embodiment taken along line A-A in FIG. 2;

FIG. 4 is a diagram illustrating an example of a hardware configuration of the image forming apparatus according to the embodiment;

FIG. 5 is a diagram illustrating an example of a configuration of functional blocks of a controller of the image forming apparatus according to the embodiment;

FIG. 6 is a diagram for describing a tap operation and a long press operation on the operation input device of the image forming apparatus according to the embodiment;

FIG. 7 is a diagram for describing a swipe operation on the operation input device of the image forming apparatus according to the embodiment;

FIG. 8A is a flowchart illustrating an example of a procedure of a process related to an operation on the operation input device of the image forming apparatus according to the embodiment; and

FIG. 8B is a flowchart illustrating an example of the procedure of the process related to an operation on the operation input device of the image forming apparatus according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

For input operations on devices, fingers of operators are sometimes unsuitable for touch operations, such as when the fingers are dirty, covered by gloves, adorned with artificial nails, or belong to prosthetic hands. Some operators are unwilling to directly touch the screen due to the recent pandemic. Thus, input devices that enable touchless input are increasingly used in response to the wish of not directly touching the screen for operations. For example, the input devices that enable touchless input have already been adopted for elevator buttons, kitchen faucets, and restaurant menus, for example.

In a technique related to such a touch or touchless operation, in order to allow operators to perform the intended touch or touchless operation, the input mode is switched to change the operation to the touch or touchless operation.

In the technique of the related art, however, the input mode is switched between the touch input and the touchless input with a switching operation member prior to the operation. Additionally, the technique assumes a limited operation range based on input by a tap operation. Consequently, the technique fails to handle general input actions specific to operations on touch panels, such as swipe and long press operations as well as the tap operation.

According to one aspect of the present disclosure, an operator can perform a desired operation which may be a touch or touchless operation without switching the input mode in advance.

An input device and an image forming apparatus according to an embodiment of the present disclosure will be described in detail below with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### External Configuration of Image Forming Apparatus

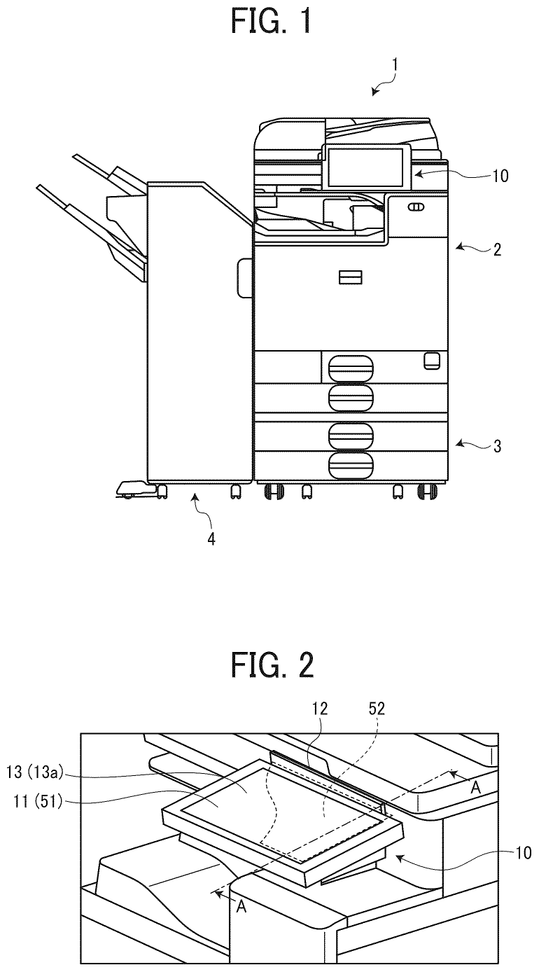

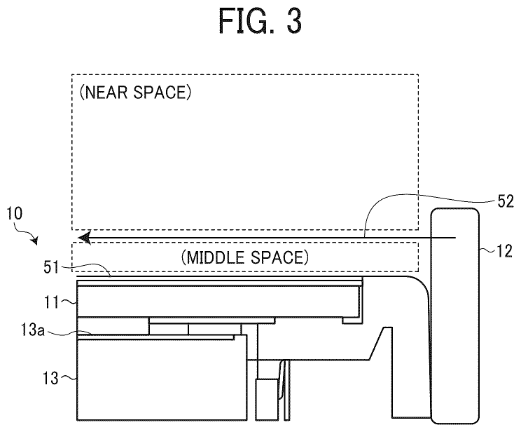

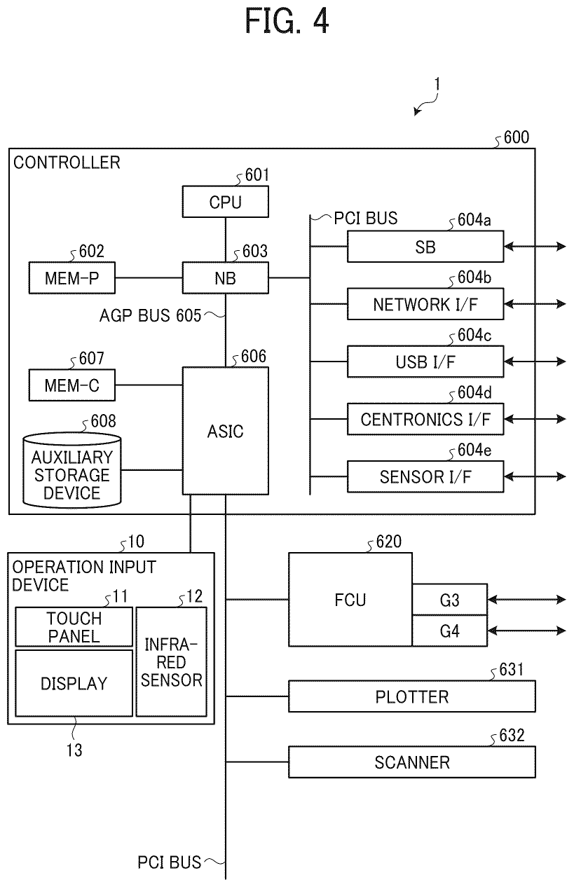

FIG. 1 is an external view of an example of an image forming apparatus according to an embodiment of the present disclosure. FIG. 2 is an external perspective view of an operation input device installed in the image forming apparatus according to the embodiment. FIG. 3 is a cross-sectional view of the operation input device installed in the image forming apparatus according to the embodiment taken along line A-A in FIG. 2. The external configuration of the image forming apparatus according to the present embodiment will be described with reference to FIGS. 1 to 3.

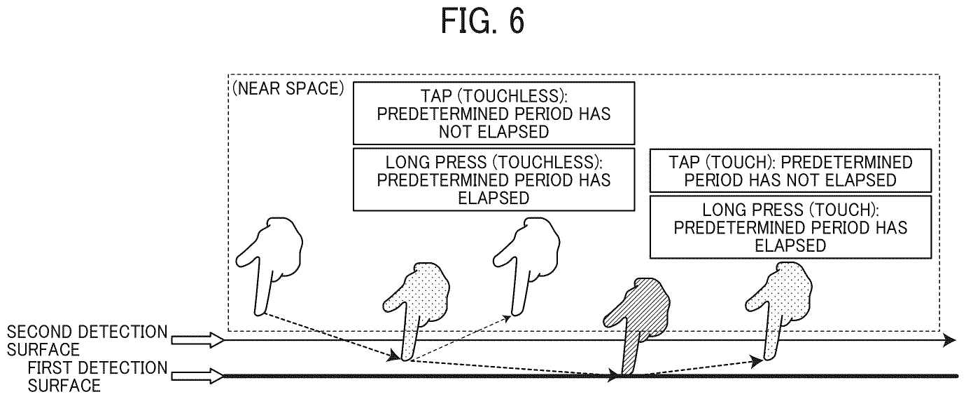

An image forming apparatus 1 illustrated in FIG. 1 is, for example, a multifunction peripheral (MFP) having at least two functions among a copy function, a printer function, a scanner function, and a facsimile function. As illustrated in FIG. 1, the image forming apparatus 1 includes a main device 2, a sheet feeding bank 3, a sheet ejection device 4, and an operation input device 10. Note that the image forming apparatus 1 is an example of an “image forming apparatus” according to embodiments of the present disclosure. When the operation input device 10 includes a central processing unit (CPU) to have a computation function, the operation input device 10 is an example of the “input device” according to embodiments of the present disclosure. Additionally, any device including the operation input device 10 and having functional units illustrated in FIG. 5 (described below) just like the image forming apparatus 1 according to the present embodiment is an example of the “input device” according to embodiments of the present disclosure.

The main device 2 forms an image on a sheet fed from the sheet feeding bank 3, in response to an operation performed on the operation input device 10 by an operator. The main device 2 includes a heat source which is, for example, a fixing unit that fixes a color material to the sheet having the image formed thereon or a dryer that dries the color material.

The sheet feeding bank 3 is an optional device that is loaded with sheets and feeds a sheet to the main device 2 in response to a command from the main device 2.

The sheet ejection device 4 is an optional device that performs a sheet ejection operation on the sheet having the image formed thereon by the main device 2, in response to a command from the main device 2.

The operation input device 10 receives an operation from the operator and displays various screens or the like. As illustrated in FIGS. 2 and 3, the operation input device 10 includes a touch panel 11, an infrared sensor 12, and a display 13. The touch panel 11 is an example of a first detector. The infrared sensor 12 is an example of a second detector.

The touch panel 11 receives a touch operation performed with a finger of the operator. A surface of the touch panel 11 touched with a finger of the operator serves as a first detection surface 51. As illustrated in FIGS. 2 and 3, the first detection surface 51 is parallel to a display surface 13a of the display 13 to detect a touch of the finger of the operator.

The infrared sensor 12 emits an infrared ray (or infrared light) to detect the finger of the operator in a touchless manner. As illustrated in FIGS. 2 and 3, the infrared sensor 12 forms a second detection surface 52 for detecting the finger of the operator in a touchless manner with an optical path of the emitted infrared ray. As illustrated in FIG. 3, the second detection surface 52 is on a near side (i.e., a side closer to the operator) with respect to the first detection surface 51 and parallel to the first detection surface 51. That is, the second detection surface 52 is parallel to the first detection surface 51 and is separated from the first detection surface 51 by a predetermined distance on a side of the first detection surface 51 that is opposite to a side on which the display 13 is disposed. The infrared sensor 12 detects the presence of a finger with respect to the second detection surface 52 and a position of the finger at the second detection surface 52.

In the description, a space on the near side, that is, on the side closer to the operator, relative to the second detection surface 52 may be referred to as a “near space” and a space between the first detection surface 51 and the second detection surface 52 may be referred to as a “middle space” as illustrated in FIG. 3.

The display 13 is disposed on a side of the touch panel 11 opposite to the second detection surface 52. The display 13 is implemented by a liquid crystal display or organic light-emitting diode (OLED) display that displays various kinds of information such as buttons and screens through the touch panel 11.

In the example illustrated in FIG. 1, the sheet feeding bank 3 and the sheet ejection device 4 are illustrated as optional devices included in the image forming apparatus 1. However, the configuration of the image forming apparatus 1 is not limited to this example, and may include another optional device such as an automatic reversing document feeder (ARDF) or a card reader.

### Hardware Configuration of Image Forming Apparatus

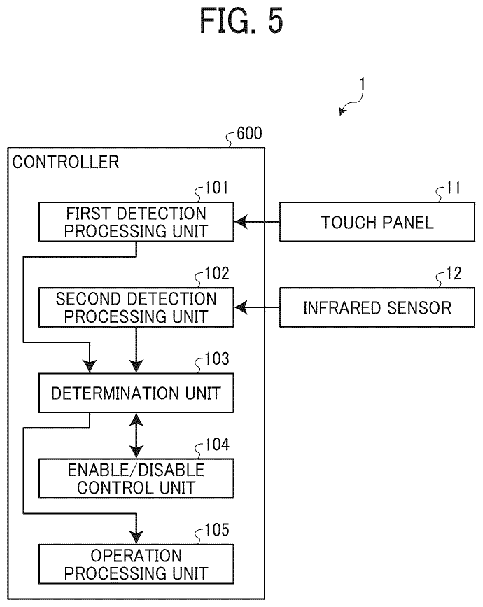

FIG. 4 is a diagram illustrating an example of a hardware configuration of the image forming apparatus according to the present embodiment. The hardware configuration of the image forming apparatus 1 according to the present embodiment will be described with reference to FIG. 4.

As illustrated in FIG. 4, the image forming apparatus 1 includes a controller 600, the operation input device 10, a facsimile control unit (FCU) 620, a plotter 631, and a scanner 632 that are connected to one another by a Peripheral Component Interface (PCI) bus.

The controller 600 is a device that controls overall operations, drawings, and communication performed by the image forming apparatus 1 and controls input from the operation input device 10.

As described above, the operation input device 10 receives a touch operation and a touchless operation respectively performed with a finger of an operator on the first detection surface 51 and with respect to the second detection surface 52. The operation input device 10 also displays the state or the like of the image forming apparatus 1 (i.e., has a display function). The operation input device 10 is directly connected to an application specific integrated circuit (ASIC) 606 (described later).

The FCU 620 is a device that implements a facsimile function of Group 3 (G3) and Group 4 (G4). The FCU 620 is connected to the ASIC 606 by the PCI bus, for example.

The plotter 631 is a device that implements the printer function. The plotter 631 is connected to the ASIC 606 by the PCI bus, for example.

The scanner 632 is a device that implements the scanner function. The scanner 632 is connected to the ASIC 606 by the PCI bus, for example.

As illustrated in FIG. 4, the controller 600 includes a CPU 601, a system memory (MEM-P) 602, a northbridge (NB) 603, a southbridge (SB) 604a, a network interface (I/F) 604b, a Universal Serial Bus (USB) I/F 604c, a Centronics I/F 604d, a sensor I/F 604e, the ASIC 606, a local memory (MEM-C) 607, and an auxiliary storage device 608.

The CPU 601 is an arithmetic device that controls the entire image forming apparatus 1. The CPU 601 is connected to a chipset including the system memory 602, the northbridge 603, and the southbridge 604a, and is connected to another device through this chipset. The system memory 602 is used as a memory for storing a program and data, a memory for loading the program and the data, and a printer rendering memory. The system memory 602 includes a read-only memory (ROM) and a random access memory (RAM). The ROM is read-only and is used as the memory for storing a program and data. The RAM is rewritable and readable and is used as the memory for loading the program and the data and the printer rendering memory.

The northbridge 603 connects the CPU 601 and the system memory 602, the southbridge 604a, and an accelerated graphics port (AGP) bus 605 to each other. The northbridge 603 includes a memory controller that controls reading and writing from and to the system memory 602, a PCI master, and an AGP target.

The southbridge 604a connects the northbridge 603 and a PCI device and a peripheral device to each other. The southbridge 604a is connected to the northbridge 603 through the PCI bus. To the PCI bus, the network I/F 604b, the USB I/F 604c, the Centronics I/F 604d, and the sensor I/F 604e, for example, are connected.

The AGP bus 605 is a bus interface for a graphics accelerator card that is proposed for accelerating processing of graphics. The AGP bus 605 directly accesses the system memory 602 with high throughput to accelerate the graphics accelerator card.

The ASIC 606 is an integrated circuit (IC) dedicated to image processing and including hardware elements for image processing. The ASIC 606 functions as a bridge for connecting the AGP bus 605, the PCI bus, the auxiliary storage device 608, and the local memory 607 to each other. The ASIC 606 includes a PCI target, an AGP master, an arbiter (ARB) serving as a central processor of the ASIC 606, a memory controller that controls the local memory 607, a plurality of direct memory access controllers (DMACs) that perform rotation or the like of image data with a hardware logic, and a PCI unit that performs data transfer between the ASIC 606 and the plotter 631 and between the ASIC 606 and the scanner 632 through the PCI bus. To the ASIC 606, for example, the FCU 620, the plotter 631, and the scanner 632 are connected through the PCI bus.

The local memory 607 is used as a buffer for image data to be copied and as a code buffer.

The auxiliary storage device 608 is a storage device such as a hard disk drive (HDD), a solid state drive (SSD), a secure digital (SD) card, or a flash memory. The auxiliary storage device 608 serves as storage that stores image data, programs, font data, and forms, for example.

The hardware configuration of the image forming apparatus 1 illustrated in FIG. 4 is an example. In some embodiments, the image forming apparatus 1 does not necessarily include all the component devices. In some embodiments, the image forming apparatus 1 may include another component device.

### Configuration and Operation of Functional Blocks of Controller of Image Forming Apparatus

FIG. 5 is a diagram illustrating an example of a configuration of functional blocks of the controller of the image forming apparatus according to the embodiment. The configuration and operation of the functional blocks of the controller 600 of the image forming apparatus 1 according to the present embodiment will be described with reference to FIG. 5.

As illustrated in FIG. 5, the controller 600 includes a first detection processing unit 101, a second detection processing unit 102, a determination unit 103, an enable/disable control unit 104 (disabling unit), and an operation processing unit 105.

The first detection processing unit 101 is a functional unit that detects a touch operation on the touch panel 11. That is, the first detection processing unit 101 detects the presence or absence of a touch of a finger of an operator on the first detection surface 51 formed by the touch panel 11. The first detection processing unit 101 further acquires (coordinate) information on the position touched with the finger on the first detection surface 51.

The second detection processing unit 102 is a functional unit that detects a touchless operation with the infrared sensor 12. That is, the second detection processing unit 102 detects a touchless operation performed with a finger of an operator with respect to the second detection surface 52 formed by the infrared sensor 12. The second detection processing unit 102 further acquires (coordinate) information on the position where the finger is detected at the second detection surface 52.

The determination unit 103 is a functional unit that determines a distance by which the finger of the operator is moved using a threshold value and determines a period for which the finger is detected on the first detection surface 51 and with respect to the second detection surface 52 using a threshold value, based on detection results obtained by the first detection processing unit 101 and the second detection processing unit 102.

The enable/disable control unit 104 is a functional unit that performs control to enable or disable the detection function of the first detection surface 51 and the detection function of the second detection surface 52 in accordance with a result determined by the determination unit 103. For example, disabling the first detection surface 51 indicates that the first detection processing unit 101 disconnects communication with the touch panel 11 or stops performing processing in response to a detection signal from the touch panel 11, for example. On the other hand, enabling the first detection surface 51 indicates that the first detection processing unit 101 resumes performing the processing in response to a detection signal from the touch panel 11. The same applies to disabling and enabling the second detection surface 52.

The operation processing unit 105 is a functional unit that determines the type of the operation performed on the first detection surface 51 or with respect to the second detection surface 52 in accordance with a result determined by the determination unit 103, and performs processing corresponding to the type.

The first detection processing unit 101, the second detection processing unit 102, the determination unit 103, the enable/disable control unit 104, and the operation processing unit 105 described above are implemented by execution of a program by the CPU 601 illustrated in FIG. 4. Note that at least part of the first detection processing unit 101, the second detection processing unit 102, the determination unit 103, the enable/disable control unit 104, and the operation processing unit 105 may be implemented by hardware such as an integrated circuit or by a combination of software and hardware.

The functional units of the controller 600 of the image forming apparatus 1 illustrated in FIG. 5 are conceptually presented functions, and are not limited to such a configuration. For example, a plurality of functional units illustrated as independent functional units of the controller 600 of the image forming apparatus 1 in FIG. 5 may be configured as a single functional unit. Conversely, the function of a single functional unit of the controller 600 of the image forming apparatus 1 illustrated in FIG. 5 may be divided into a plurality of functions and configured as a plurality of functional units. That is, the functional units of the controller 600 of the image forming apparatus 1 are not necessarily configured as clear software modules, i.e., the blocks illustrated in FIG. 5. As a result of the execution of the program, the functions of the functional units are implemented in the controller 600 as a whole.

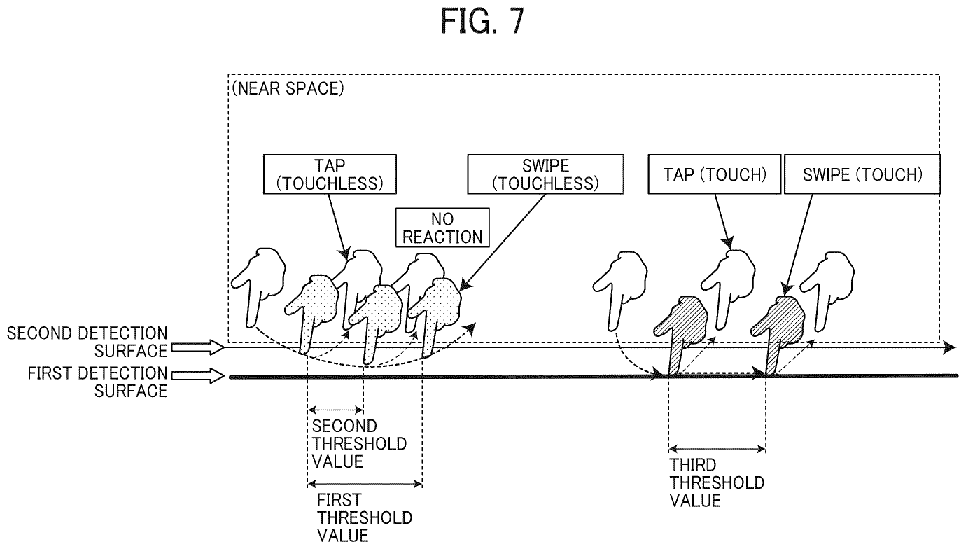

Details about Tap Operation and Long Press Operation FIG. 6 is a diagram for describing a tap operation and a long press operation on the operation input device of the image forming apparatus according to the embodiment. Details of a tap operation and a long press operation on the operation input device 10 of the image forming apparatus 1 according to the present embodiment will be described with reference to FIG. 6.

The tap operation will be described with reference to FIG. 6 and Table 1 below. When the finger of the operator is in the space on the near side (in the near space) of the second detection surface 52, the first detection surface 51 and the second detection surface 52 are both in an enabled state in which detection is enabled ((Tp1) in Table 1).

To point to a target position with the finger on a screen displayed on the display 13, the finger is moved to pass by the second detection surface 52 ((Tp2) in Table 1) and enter the space (middle space) between the first detection surface 51 and the second detection surface 52 ((Tp3) in Table 1). When the first detection processing unit 101 detects a touch of the finger on the first detection surface 51 thereafter, the enable/disable control unit 104 disables the second detection surface 52 ((Tp4-2-1) in Table 1).

When the first detection processing unit 101 detects the separation of the finger from the first detection surface 51 thereafter, the operation processing unit 105 determines the operation with the finger as a tap operation (touch) ((Tp4-2-2) in Table 1), and performs processing corresponding to the tap operation (touch).

When the second detection processing unit 102 detects the movement of the finger from the middle space to the near space without the finger touching the first detection surface 51 before the determination unit 103 determines a predetermined period has elapsed, the operation processing unit 105 determines the operation with the finger as a tap operation (touchless) ((Tp4-1 in Table 1), and performs processing corresponding to the tap operation (touchless). The case where the second detection processing unit 102 detects the movement of the finger from the middle space to the near space indicates a case where the finger that has been detected is no longer detected by the second detection processing unit 102.

When the second detection processing unit 102 detects the movement of the finger in the middle space ((Tp4-2-3 in Table 1) to the near space after the tap operation (touch) is performed with the finger, the enable/disable control unit 104 enables the second detection surface 52 ((Tp5) in Table 1).

The operator moves the finger to pass by the second detection surface 52 and approach the first detection surface 51. In this state, the operator intends to return the finger from the middle space back to the near space and perform a tap operation (touchless) without touching the first detection surface 51 but mistakenly touches the first detection surface 51. This case does not lead to an operation mistake if a distance between the first detection surface 51 and the second detection surface 52 is set to an appropriate distance (for example, about 10 to 20 millimeters) since the finger touches the first detection surface 51 at a position right under the target position on the second detection surface 52.

TABLE 1
Tap operation

| | | | | Second | |
|---|---|---|---|---|---|
| | | Moving | | detection | |
| | Moving direction | direction of | Reaction of | surface | First detection |
| | of finger | finger | operation input | (Infrared | surface |
| Position of finger | (Far/Near) | (Plane) | unit | sensor) | (Touch panel) |
| (Tp1) Finger is near relative to second | — | — | OFF | Enabled | Enabled |
| detection surface (in near space) (initial) | | | | | |
| (Tp2) Finger is moved toward/passes by | Far | — | OFF | Enabled | Enabled |
| second detection surface | | | | | |
| (Tp3) Finger is between second detection | — | — | OFF | Enabled | Enabled |
| surface and first detection surface (in | | | | | |
| middle space) (less than predetermined | | | | | |
| period) | | | | | |
| (Tp4-1) Moved to near space | Near | — | ON | Enabled | Enabled |
| | | | (Touchless tap) | | |
| (Tp4-2-1) Finger touches first detection | — | — | OFF | Disabled | Enabled |
| surface | | | | | |
| (Tp4-2-2) Finger is separated from first | Near | — | ON | Disabled | Enabled |
| detection surface | | | (Touch tap) | | |
| (Tp4-2-3) Finger is between second | — | — | OFF | Disabled | Enabled |
| detection surface and first detection surface | | | | | |
| (in middle space) | | | | | |
| (Tp5) Finger is moved from middle space | Near | — | OFF | Enabled | Enabled |
| to near space | | | | | |

The long press operation will be described next with reference to FIG. 6 and Table 2 below. When the finger of the operator is in the space on the near side (in the near space) of the second detection surface 52, the first detection surface 51 and the second detection surface 52 are both in an enabled state in which detection is enabled ((Lp1) in Table 2).

To point to a target position with the finger on a screen displayed on the display 13, the finger is moved to pass by the second detection surface 52 ((Lp2) in Table 2). When the first detection processing unit 101 detects a touch of the finger on the first detection surface 51 before the determination unit 103 determines that the finger is positioned in the middle space for a predetermined period, the enable/disable control unit 104 disables the second detection surface 52.

When the determination unit 103 determines that the predetermined period has elapsed with the finger touching the first detection surface 51 thereafter, the operation processing unit 105 determines the operation with the finger as a long press operation (touch) ((Lp3-4) in Table 2), and performs processing corresponding to the long press operation (touch).

When the first detection processing unit 101 detects the separation of the finger from the first detection surface 51 before the determination unit 103 determines that the predetermined period has elapsed with the finger touching the first detection surface 51, the operation processing unit 105 determines the operation with the finger as a tap operation (touch) ((Lp3-3) in Table 2), and performs processing corresponding to the tap operation (touch).

To point to the target position with the finger on the screen displayed on the display 13, the finger is moved to pass by the second detection surface 52 ((Lp2) in Table 2). When the determination unit 103 determines that the predetermined period has elapsed without the finger touching the first detection surface 51, the operation processing unit 105 determines the operation with the finger as a long press operation (touchless) ((Lp3-1) in Table 2), and performs processing corresponding to the long press operation (touchless). On the other hand, when the second detection processing unit 102 detects the movement of the finger from the middle space to the near space before the determination unit 103 determines that the predetermined period has elapsed without the finger touching the first detection surface 51, the operation processing unit 105 determines the operation with the finger as a tap operation (touchless) ((Lp3-2) in Table 2), and performs processing corresponding to the tap operation (touchless).

When the second detection processing unit 102 detects the movement of the finger in the middle space to the near space after the tap operation (touch) or the long press operation (touch) is performed with the finger, the enable/disable control unit 104 enables the second detection surface 52 ((Lp4) in Table 2).

TABLE 2
Long press operation

| | Moving | Moving | | | |
|---|---|---|---|---|---|
| | direction of | direction of | Reaction of | Second detection | First detection |
| | finger | finger | operation input | surface | surface |
| Position of finger | (Far/Near) | (Plane) | unit | (Infrared sensor) | (Touch panel) |
| (Lp1) Finger is near relative to second detection surface (in | — | — | OFF | Enabled | Enabled |
| near space) (initial) | | | | | |
| (Lp2) Finger is moved toward/passes by second detection | Far | — | OFF | Enabled | Enabled |
| surface | | | | | |
| (Lp3-1) Finger is between second detection surface and first | — | — | ON | Enabled | Enabled |
| detection surface (in middle space) for predetermined period | | | (Touchless long | | |
| (with separated from first detection surface) | | | press) | | |
| (Lp3-2) Finger is moved to near space before predetermined | Near | — | ON | Enabled | Enabled |
| period elapses with finger being between second detection | | | (Touchless tap) | | |
| surface and first detection surface (in middle space) | | | | | |
| (Lp3-3) Finger touches first detection surface before | Far → | — | ON | Disabled | Enabled |
| predetermined period elapses with finger being between | Near | | (Touch tap) | | |
| second detection surface and first detection surface (in | | | | | |
| middle space), and then is separated from first detection | | | | | |
| surface | | | | | |
| (Lp3-4) Finger touches first detection surface before | Far | — | ON | Disabled | Enabled |
| predetermined period elapses with finger being between | | | (Touch long press) | | |
| second detection surface and first detection surface (in | | | | | |
| middle space), and predetermined period elapses with finger | | | | | |
| touching first detection surface | | | | | |
| (Lp4) Finger is moved from middle space to near space | Near | — | OFF | Enabled | Enabled |

### Details About Swipe Operation

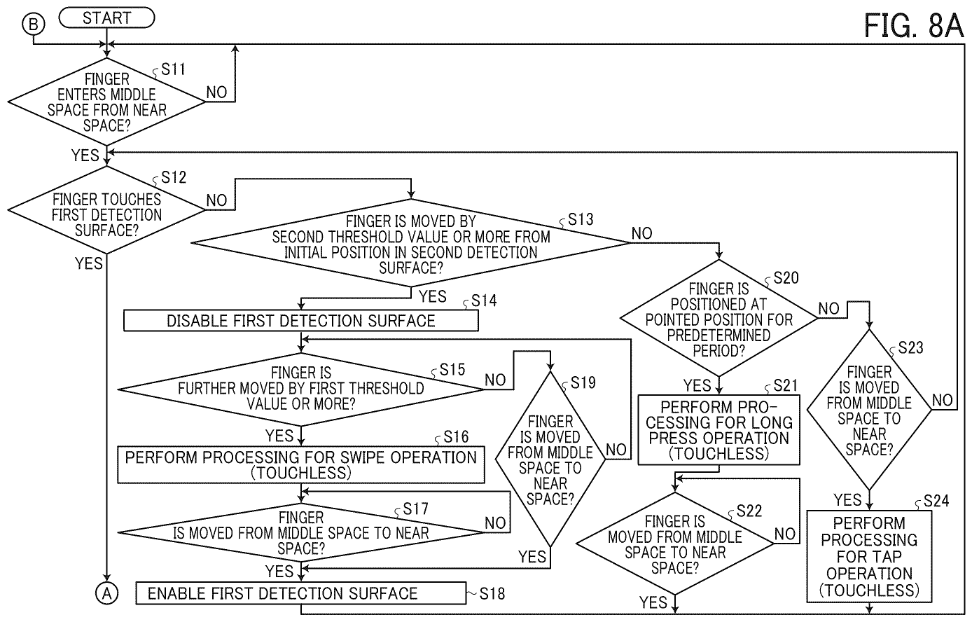

FIG. 7 is a diagram for describing a swipe operation on the operation input device of the image forming apparatus according to the embodiment. Details of a swipe operation on the operation input device 10 of the image forming apparatus 1 according to the present embodiment will be described with reference to FIG. 7 and Table 3 below.

When the finger of the operator is in the space on the near side (in the near space) of the second detection surface 52, the first detection surface 51 and the second detection surface 52 are both in an enabled state in which detection is enabled ((Sw1) in Table 3).

To point to a target position with the finger on a screen displayed on the display 13, the finger is moved to pass by the second detection surface 52 ((Sw2) in Table 3) and enter the space (middle space) between the first detection surface 51 and the second detection surface 52. When the determination unit 103 determines that the finger is moved in an in-plane direction of the first detection surface 51, that is, a direction parallel to the first detection surface 51, (hereinafter, simply referred to as an “in-plane direction”) by a second threshold value or more, the enable/disable control unit 104 disables the first detection surface 51. The second threshold value is predetermined. When the finger is further moved in the in-plane direction and the determination unit 103 determines that the finger is moved by a first threshold value (> the second threshold value) or more, the operation processing unit 105 determinedetermines the operation with the finger as a swipe operation (touchless) ((Sw3-1) in Table 3), and performs processing corresponding to the swipe operation (touchless). The first threshold value is predetermined. When the finger touches the first detection surface 51 before the finger is moved by the first threshold value or more, the operation processing unit 105 does not determinedetermine the touch of the finger as an operation because the first detection surface 51 is disabled.

After the finger enters the space (middle space) between the first detection surface 51 and the second detection surface 52, when the first detection processing unit 101 detects a touch of the finger on the first detection surface 51 before the determination unit 103 determines that the finger is moved by the second threshold value or more, the enable/disable control unit 104 disables the second detection surface 52. When the first detection processing unit 101 detects the separation of the finger from the first detection surface 51 thereafter, the operation processing unit 105 determinedetermines the operation with the finger as a tap operation (touch) ((Sw3-3) in Table 3), and performs processing corresponding to the tap operation (touch).

In the above-described case where the determination unit 103 determines that the finger is moved by the second threshold value or more, when the second detection processing unit 102 detects the movement of the finger from the middle space to the near space before the determination unit 103 determines that the finger is moved by the first threshold value or more, the operation processing unit 105 does not determinedetermine any specific operation and the enable/disable control unit 104 enables the first detection surface 51 ((Sw3-2) in Table 3).

In the above-described case where the first detection processing unit 101 detects a touch of the finger on the first detection surface 51, when the determination unit 103 determines that the finger is moved in the in-plane direction by a third threshold value or more with the finger touching the first detection surface 51, the operation processing unit 105 determinedetermines the operation with the finger as a swipe operation (touch) ((Sw3-4) in Table 3), and performs processing corresponding to the swipe operation (touch). The third threshold value is a predetermined value that is less than the first threshold value, for example.

After the finger enters the space (middle space) between the first detection surface 51 and the second detection surface 52, when the second detection processing unit 102 detects the movement of the finger from the middle space to the near space before the determination unit 103 determines that the finger is moved by the second threshold value or more, the operation processing unit 105 determinedetermines the operation with the finger as a tap operation (touchless) ((Sw3-5) in Table 3), and performs processing corresponding to the tap operation (touchless).

When the second detection processing unit 102 detects the movement of the finger in the middle space to the near space after the tap operation (touch) or the swipe operation (touch) is performed with the finger, the enable/disable control unit 104 enables the second detection surface 52 ((Sw4) in Table 3). When the second detection processing unit 102 detects the movement of the finger in the middle space to the near space after the swipe operation (touchless) is performed with the finger, the enable/disable control unit 104 enables the first detection surface 51 ((Sw4) in Table 3).

TABLE 3
Swipe operation

| | | | | Second | First |
|---|---|---|---|---|---|
| | Moving | Moving | | detection | detection |
| | direction | direction | Reaction of | surface | surface |
| | of finger | of finger | operation | (Infrared | (Touch |
| Position of finger | (Far/Near) | (Plane) | input unit | sensor) | panel) |
| (Sw1) Finger is near relative to second detection surface (in near space) (initial) | — | — | OFF | Enabled | Enabled |
| (Sw2) Finger is moved toward/passes by second detection surface | Far | — | OFF | Enabled | Enabled |
| (Sw3-1) Finger is moved in in-plane direction by second threshold value or more and | — | In-plane | ON | Enabled | Disabled |
| then by first threshold value or more between second detection surface and first | | | (Touchless | | |
| detection surface (in middle space) (with separated from first detection surface) | | | swipe) | | |
| (Sw3-2) Finger is moved to near space after finger is moved in in-plane direction by | Far → | In-plane | OFF | Enabled | Enabled |
| second threshold value or more (first detection surface is disabled) before finger is | Near | | | | |
| moved by first threshold value or more between second detection surface and first | | | | | |
| detection surface (in middle space) | | | | | |
| (Sw3-3) Finger touches first detection surface (second detection surface is disabled) | Far → | In-plane | ON | Disabled | Enabled |
| before finger is moved in in-plane direction by second threshold value or more | Near | | (Touch tap) | | |
| between second detection surface and first detection surface (in middle space), and | | | | | |
| then is separated from first detection surface | | | | | |
| (Sw3-4) Finger touches first detection surface (second detection surface is disabled) | Far | In-plane | ON | Disabled | Enabled |
| before finger is moved in in-plane direction by second threshold value or more | | | (Touch | | |
| between second detection surface and first detection surface (in middle space), and | | | swipe) | | |
| then is moved by third threshold value or more with finger touching first detection | | | | | |
| surface | | | | | |
| (Sw3-5) Finger is moved to near space before finger is moved in in-plane direction by | Near | In-plane | ON | Enabled | Enabled |
| second threshold value or more between second detection surface and first detection | | | (Touchless | | |
| surface (in middle space) | | | tap) | | |
| (Sw4) Finger is moved from middle space to near space | Near | — | OFF | Enabled | Enabled |

### Procedure of Process Related to Operation on Operation Input Device of Image Forming Apparatus

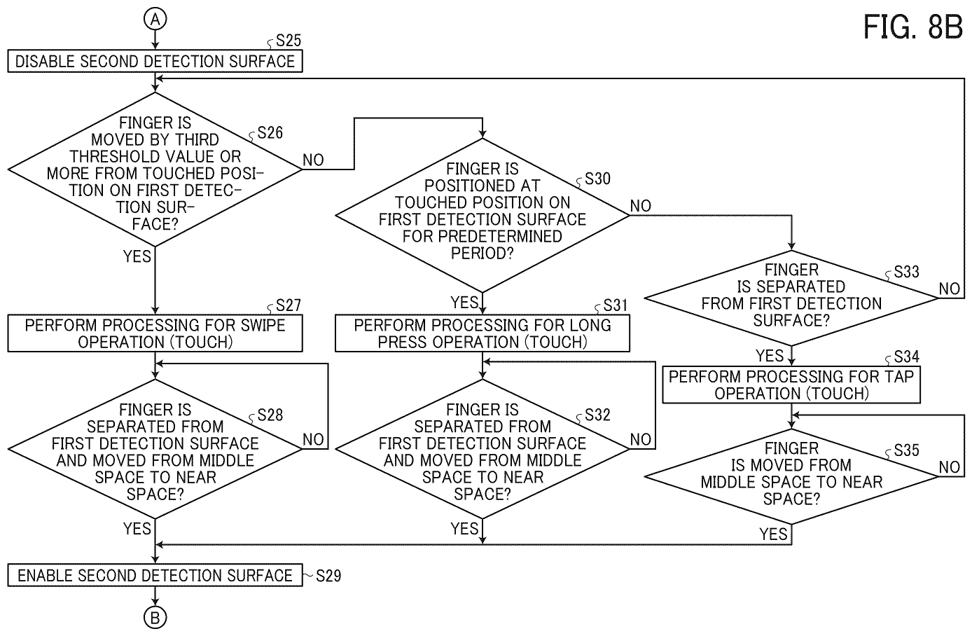

FIGS. 8A and 8B are flowcharts illustrating an example of a procedure of a process related to an operation on the operation input device of the image forming apparatus according to the embodiment. The procedure of the process related to an operation on the operation input device 10 of the image forming apparatus 1 according to the present embodiment will be described with reference to FIGS. 8A and 8B.

### Step S11

If the second detection processing unit 102 detects a finger that has moved from the near space to the middle space with the second detection surface 52 (step S11: Yes), the process then proceeds to step S12.

### Step S12

If the first detection processing unit 101 detects a touch of the finger on the first detection surface 51 (step S12: Yes) thereafter, the process proceeds to step S25. If the first detection processing unit 101 does not detect a touch of the finger on the first detection surface 51 (step S12: No), the process proceeds to step S13.

### Step S13

If the determination unit 103 determines that the finger is moved in the in-plane direction by the second threshold value or more without the finger touching the first detection surface 51 (step S13: Yes), the process proceeds to step S14. If the determination unit 103 does not determine that the finger is moved in the in-plane direction by the second threshold value or more (step S13: No), the process proceeds to step S20.

### Step S14

The enable/disable control unit 104 disables the first detection surface 51. Then, the process proceeds to step S15.

### Step S15

The determination unit 103 further determines whether the finger is moved in the in-plane direction by the first threshold value (> the second threshold value) or more. If the finger is moved by the first threshold value or more (step S15: Yes), the process proceeds to step S16. If the finger is not moved by the first threshold value or more (step S15: No), the process proceeds to step S19.

### Step S16

In this case, the operation processing unit 105 determinedetermines the operation with the finger as a swipe operation (touchless), and performs processing corresponding to the swipe operation (touchless). Then, the process proceeds to step S17.

### Step S17

If the second detection processing unit 102 detects the movement of the finger from the middle space to the near space (step S17: Yes), the process proceeds to step S18.

### Step S18

The enable/disable control unit 104 enables the first detection surface 51. Then, the process returns to step S11.

### Step S19

If the second detection processing unit 102 detects the movement of the finger from the middle space to the near space before the finger is moved by the first threshold value or more (step S19: Yes), the process proceeds to step S18. If the second detection processing unit 102 does not detect such a movement (step S19: No), the process returns to step S15.

### Step S20

If the determination unit 103 determines that a predetermined period has elapsed since the finger is positioned at a position pointed to by the finger before the finger is moved by the second threshold value or more (step S20: Yes), the process proceeds to step S21. If the determination unit 103 determines that the predetermined period has not elapsed (step S20: No), the process proceeds to step S23.

### Step S21

In this case, the operation processing unit 105 determinedetermines the operation with the finger as a long press operation (touchless), and performs processing corresponding to the long press operation (touchless).

### Step S22

If the second detection processing unit 102 detects the movement of the finger from the middle space to the near space (step S22: Yes), the process returns to step S11.

### Step S23

If the second detection processing unit 102 detects the movement of the finger from the middle space to the near space before the determination unit 103 determines that the predetermined period has elapsed since the finger is positioned at the pointed position (step S23: Yes), the process proceeds to step S24. If the second detection processing unit 102 does not detect such a movement (step S23: No), the process returns to step S12.

### Step S24

In this case, the operation processing unit 105 determinedetermines the operation with the finger as a tap operation (touchless), and performs processing corresponding to the tap operation (touchless). Then, the process returns to step S11.

### Step S25

The enable/disable control unit 104 disables the second detection surface 52 when the first detection processing unit 101 detects a touch of the finger on the first detection surface 51. Then, the process proceeds to step S26.

### Step S26

The determination unit 103 determines whether the finger is moved in the in-plane direction by the third threshold value or more with the finger touching the first detection surface 51. If the finger is moved by the third threshold value or more (step S26: Yes), the process proceeds to step S27. If the finger is not moved by the third threshold value or more (step S26: No), the process proceeds to step S30.

### Step S27

In this case, the operation processing unit 105 determinedetermines the operation with the finger as a swipe operation (touch), and performs processing corresponding to the swipe operation (touch). Then, the process proceeds to step S28.

### Step S28

If the first detection processing unit 101 detects the separation of the finger from the first detection surface 51 and the second detection processing unit 102 detects the movement of the finger from the middle space to the near space (step S28: Yes), the process proceeds to step S29.

### Step S29

The enable/disable control unit 104 enables the second detection surface 52. Then, the process returns to step S11.

### Step S30

If the determination unit 103 determines that a predetermined period has elapsed since the finger is positioned at the touched position on the first detection surface 51 before the finger is moved by the third threshold value or more (step S30: Yes), the process proceeds to step S31. If the determination unit 103 determines that the predetermined period has not elapsed (step S30: No), the process proceeds to step S33.

### Step S31

In this case, the operation processing unit 105 determinedetermines the operation with the finger as a long press operation (touch), and performs processing corresponding to the long press operation (touch). Then, the process proceeds to step S32.

### Step S32

If the first detection processing unit 101 detects the separation of the finger from the first detection surface 51 and the second detection processing unit 102 detects the movement of the finger from the middle space to the near space (step S32: Yes), the process proceeds to step S29.

### Step S33

If the first detection processing unit 101 detects the separation of the finger from the first detection surface 51 before the predetermined period elapses since the finger is positioned at the touched position on the first detection surface 51 (step S33: Yes), the process proceeds to step S34. If the first detection processing unit 101 does not detect the separation (step S33: No), the process returns to step S26.

### Step S34

In this case, the operation processing unit 105 determinedetermines the operation with the finger as a tap operation (touch), and performs processing corresponding to the tap operation (touch). Then, the process proceeds to step S35.

### Step S35

If the second detection processing unit 102 detects the movement of the finger from the middle space to the near space (step S35: Yes), the process proceeds to step S29.

As described above, in the image forming apparatus 1 according to the present embodiment, the display 13 displays information. The touch panel 11 has the first detection surface 51. The first detection surface 51 is parallel to the display surface 13a of the display 13 and detects a touch of a finger of an operator. The infrared sensor 12 forms the second detection surface 52. The second detection surface 52 is parallel to the first detection surface 51 and is separated from the first detection surface 51 by a predetermined distance on a side of the first detection surface 51 that is opposite to a side on which the display 13 is disposed. The second detection surface 52 detects the finger of the operator in a touchless manner. In the case where the touch panel 11 does not detect a touch of the finger of the operator and the infrared sensor 12 detects the finger of the operator, the operation processing unit 105 determines a touchless operation. In the case where the touch panel 11 detects a touch of the finger of the operator, the enable/disable control unit 104 disables the second detection surface 52. When the second detection surface 52 is disabled, the operation processing unit 105 determines a touch operation on the first detection surface 51. This allows the operator to perform a desired operation which may be a touch or touchless operation without switching the input mode in advance.

In the image forming apparatus 1 according to the present embodiment, the enable/disable control unit 104 disables the first detection surface 51 when the finger of the operator is moved by a second threshold value or more while the finger is detected by the infrared sensor 12 in the case where the touch panel 11 does not detect a touch of the finger of the operator and the infrared sensor 12 detects the finger of the operator. This can stop recognition of a touch operation with the first detection surface 51 and enable recognition of a touchless operation with the second detection surface 52.

In the image forming apparatus 1 according to the present embodiment, the enable/disable control unit 104 enables the second detection surface 52 in the case where the infrared sensor 12 no longer detects the finger of the operator after the second detection surface 52 is disabled. This can reset the state of the operation input device 10 and allow the operator to perform a desired operation which may be a touch or touchless operation again.

In the image forming apparatus 1 according to the present embodiment, the enable/disable control unit 104 enables the first detection surface 51 in the case where the infrared sensor 12 no longer detects the finger of the operator after the first detection surface 51 is disabled. This can reset the state of the operation input device 10 and allow the operator to perform a desired operation which may be a touch or touchless operation again.

An input device includes a display 13 having a display surface 13a to display information; a first detector (e.g., the touch panel 11) having a first detection surface 51 parallel to the display surface 13a, to detect an object contacting the first detection surface 51 to detect a contact operation performed by the object. The second detector (e.g., the infrared sensor 12) emits light to form a second detection surface 52; and detects the object on the second detection surface 52 to detect a non-contact operation performed by the object. The second detection surface is parallel to the first detection surface 51 and separated from the first detection surface 51 by a predetermined distance. The circuitry (e.g., the controller 600) determines that the non-contact operation is performed on the second detection surface by the object when the second detector detects the object on the second detection surface (S11) and when the first detector does not detect the object contacting the first detection surface (S12, NO); disables the second detection surface (S25) when the first detector detects that the object contacts the display surface; and determines a type of the contact operation performed on the first detection surface by the object (S26, S30, S33) when the second detection surface 52 has been disabled (S25).

The circuitry (e.g., the controller 600) determines whether the object is moved in an in-plane direction on the second detection surface 52 by a predetermined threshold value or more detected by the second detector (S13, S20, S23) when the second detector detects the object (S11, YES) and when the first detector does not detect the object (S12, NO); disables the first detection surface (S14) when the object is moved in the in-plane direction by the predetermined threshold value or more (S13); and determines a type of the non-contact operation performed on the second detection surface by the object (S13, S20, S23).

The circuitry (e.g., the controller 600) does not determine that the contact operation is performed on the first detection surface 51 of the first detector (e.g., the touch panel 11) when the first detector detects the object contacting the first detection surface (51) after the first detection surface has been disabled.

The circuitry (e.g., the controller 600) enables the second detection surface when the second detector does not detect the object after the second detection surface (S25) has been disabled.

The circuitry (e.g., the controller 600) enables the first detection surface when the second detector does not detect the object (S17, S18, S19) after the first detection surface (S14) has been disabled.

The first detector includes a touch panel to detect the object contacting the first detection surface.

The second detector includes an infrared sensor to emit infrared light having an infrared optical path to form the second detection surface.

The second detector has the predetermined distance between the first detection surface and the second detection surface from 10 to 20 millimeters.

An image forming apparatus includes the input device as described above and a plotter to form an image according to a movement of the object detected by the first detector (e.g., the touch panel 11) and the second detector (e.g., the infrared sensor 12) of the input device.

The circuitry (e.g., the controller 600) determines whether the object is moved in an in-plane direction on the first detection surface (52) by a predetermined threshold value or more detected by the first detector (S26, S30, S33) when the first detector detects the object (S12, YES) and when the second detection surface has been disabled (S25); and determines the type of the contact operation performed on the first detection surface by the object (S26, S30, S33).

The second detector (e.g., the infrared sensor 12) detects the non-contact operation including at least one of a swipe operation, a long press operation, or a tap operation.

The first detector (e.g., the touch panel 11) detects the contact operation including at least one of a swipe operation, a long press operation, or a tap operation.

Each of the functions of the above-described embodiment may be implemented by one or more processing circuits. Herein, examples of the “processing circuits” include a processor programmed to implement the functions based on software such as a processor implemented by an electronic circuit, and devices such as an ASIC, a digital signal processor (DSP), a field-programmable gate array (FPGA), and a circuit module of the related art that are designed to implement the functions described above.

The programs executed by the image forming apparatus 1 in the above-described embodiment may be preinstalled in the ROM or the like and provided to the image forming apparatus 1. The programs executed by the image forming apparatus 1 in the above-described embodiment may be stored as a file in an installable format or an executable format on a computer-readable recording medium such as a compact disc read-only memory (CD-ROM), a flexible disk (FD), a compact disc-recordable (CD-R), or a digital versatile disc (DVD) and may be provided as a computer program product. Alternatively, the programs executed by the image forming apparatus 1 in the above-described embodiment may be stored on a computer connected to a network such as the Internet so that the programs can be downloaded and provided via the network. The programs executed by the image forming apparatus 1 in the above-described embodiment may be provided or distributed via a network such as the Internet.

The programs executed by the image forming apparatus 1 in the above-described embodiment have a module configuration including the functional units described above. The CPU (processor) that is actual hardware reads the programs from the ROM and executes the programs, so that the above-described functional units are loaded to a main storage device and are generated in the main storage device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are as follows.

According to Aspect 1, an input device includes a display, a first detector, a second detector, an operation processing unit, and a disabling unit.

The display displays information.

The first detector has a first detection surface. The first detection surface is parallel to a display surface of the display and detects a touch of a finger of an operator.

The second detector forms a second detection surface. The second detection surface is parallel to the first detection surface and is separated from the first detection surface by a predetermined distance on a side of the first detection surface that is opposite to a side on which the display is disposed. The second detection surface detects the finger of the operator in a touchless manner.

The operation processing unit determines a touchless operation with respect to the second detection surface in a case where the first detector does not detect a touch of the finger of the operator and the second detector detects the finger of the operator.

The disabling unit disables the second detection surface in a case where the first detector detects a touch of the finger of the operator.

The operation processing unit determines a touch operation on the first detection surface in a case where the second detection surface is disabled.

According to Aspect 2, in the input device of Aspect 1, the disabling unit disables the first detection surface when the finger of the operator is moved by a predetermined threshold value or more while the finger is detected by the second detector in the case where the first detector does not detect a touch of the finger of the operator and the second detector detects the finger of the operator.

According to Aspect 3, in the input device of Aspect 2, the operation processing unit does not determine a touch of the finger of the operator on the first detection surface as an operation after the first detection surface is disabled.

According to Aspect 4, in the input device of any one of Aspects 1 to 3, the disabling unit enables the second detection surface in a case where the second detector no longer detects the finger of the operator after the second detection surface is disabled.

According to Aspect 5, in the input device of Aspect 2 or 3, the disabling unit enables the first detection surface in a case where the second detector no longer detects the finger of the operator after the first detection surface is disabled.

According to Aspect 6, in the input device of any one of Aspects 1 to 5, the first detector includes a touch panel to detect a touch.

According to Aspect 7, in the input device of any one of Aspects 1 to 6, the second detector includes an infrared sensor.

The second detection surface is formed by an optical path of an infrared ray emitted by the infrared sensor.

According to Aspect 8, in the input device of any one of Aspects 1 to 7, the predetermined distance between the first detection surface and the second detection surface is 10 to 20 millimeters.

According to Aspect 9, an image forming apparatus includes a display, a first detector, a second detector, an operation processing unit, and a disabling unit.

The display displays information.

The first detector has a first detection surface. The first detection surface is parallel to a display surface of the display and detects a touch of a finger of an operator.

The second detector forms a second detection surface. The second detection surface is parallel to the first detection surface and is separated from the first detection surface by a predetermined distance on a side of the first detection surface that is opposite to a side on which the display is disposed. The second detection surface detects the finger of the operator in a touchless manner.

The operation processing unit determines a touchless operation with respect to the second detection surface in a case where the first detector does not detect a touch of the finger of the operator and the second detector detects the finger of the operator.

The disabling unit disables the second detection surface in a case where the first detector detects a touch of the finger of the operator.

The operation processing unit determines a touch operation on the first detection surface in a case where the second detection surface is disabled.

1. An input device comprising:
a display having a display surface to display information;
a first detector, having a first detection surface parallel to the display surface, to detect an object contacting the first detection surface to detect a contact operation performed by the object;
a second detector to:
emit light to form a second detection surface; and
detect the object on the second detection surface to detect a non-contact operation performed by the object, and
the second detection surface being:
parallel to the first detection surface; and
separated from the first detection surface by a predetermined distance; and
circuitry configured to:
determine that the non-contact operation is performed on the second detection surface by the object,
when the second detector detects the object on the second detection surface; and
when the first detector does not detect the object contacting the first detection surface;
disable the second detection surface when the first detector detects that the object contacts the first detection surface; and
determine a type of the contact operation performed on the first detection surface by the object when the second detection surface has been disabled.

2. The input device according to claim 1,
wherein the circuitry is further configured to:
determine whether the object is moved in an in-plane direction on the second detection surface by a predetermined threshold value or more detected by the second detector,
when the second detector detects the object; and
when the first detector does not detect the object;
disable the first detection surface,
when the object is moved in the in-plane direction by the predetermined threshold value or more; and
determine a type of the non-contact operation performed on the second detection surface by the object.

3. The input device according to claim 2,
wherein the circuitry does not determine that the contact operation is performed on the first detection surface of the first detector,
when the first detector detects the object contacting the first detection surface after the first detection surface has been disabled.

4. The input device according to claim 1,
wherein the circuitry is further configured to enable the second detection surface,
when the second detector does not detect the object after the second detection surface has been disabled.

5. The input device according to claim 2,
wherein the circuitry is further configured to enable the first detection surface,
when the second detector does not detect the object after the first detection surface has been disabled.

6. The input device according to claim 1,
wherein the first detector includes a touch panel to detect the object contacting the first detection surface.

7. The input device according to claim 1,
wherein the second detector includes an infrared sensor to emit infrared light having an infrared optical path to form the second detection surface.

8. The input device according to claim 1,
wherein the second detector has the predetermined distance between the first detection surface and the second detection surface from 10 to 20 millimeters.

9. An image forming apparatus comprising:
the input device according to claim 1; and
a plotter to form an image according to a movement of the object detected by the first detector and the second detector of the input device.

10. The input device according to claim 1,
wherein the circuitry is further configured to:
determine whether the object is moved in an in-plane direction on the first detection surface by a predetermined threshold value or more detected by the first detector,
when the first detector detects the object; and
when the second detection surface has been disabled; and
determine the type of the contact operation performed on the first detection surface by the object.

11. The input device according to claim 1,
wherein the second detector detects the non-contact operation including at least one of a swipe operation, a long press operation, or a tap operation.

12. The input device according to claim 1,
wherein the first detector detects the contact operation including at least one of a swipe operation, a long press operation, or a tap operation.
